(19) United States
(12) Patent Application Publication
(10) Pub. No.: US 2011/0128380 A1
(43) Pub. Date: Jun. 2, 2011

(54) CAMERA CONTROL APPARATUS AND METHOD OF CONTROLLING A CAMERA

(75) Inventors: Toru TSURUTA, Kawasaki (JP); Takeshi Morikawa, Kawasaki (JP)

(73) Assignee: FUJITSU LIMITED, Kawasaki-shi (JP)

(21) Appl. No.: 12/954,991

(22) Filed: Nov. 29, 2010

(30) Foreign Application Priority Data
Nov. 30, 2009 (JP) 2009-272624

(51) Int. Cl. H04N 7/18; H04N 5/907

(52) U.S. Cl. 348/148; 348/231.99; 348/E07.085

(57) ABSTRACT

A camera control apparatus which controls an exposure time of a camera that takes a moving image, the camera includes a memory for storing the moving image taken by the camera, an image capturing unit for capturing the moving image from the camera and storing the moving image into the memory, a first candidate generator for generating the first candidate of the exposure time on the basis of a speed of the movable body, a second candidate generator for generating a second candidate of the exposure time on the basis of the moving image stored in the memory, and, a setting unit for selecting a shorter time between the first candidate and the second candidate, and for setting the selected candidate as the exposure time.

### CROSS-REFERENCE TO RELATED APPLICATION

This application is based upon and claims the benefit of priority of the prior Japanese Patent Application No. 2009-272624, filed on Nov. 30, 2009, the entire contents of which are incorporated herein by reference.

### FIELD

The embodiments discussed herein are related to a camera control apparatus and a method of controlling a camera.

### BACKGROUND

A movable body such as a vehicle may carry a camera system that displays an image captured by a camera mounted on the movable body on a display.

The camera system generates a moving image by continuously capturing frames of image data of still images that are captured by exposing an object for a predetermined time using a camera mounted on the movable body in a short time, and displaying the image data captured continuously while switching the images in a continuous manner. Therefore, in such a camera system, the shorter the exposure time per frame is, the greater the number of frames that can be captured in a unit of time can be, so that it is possible to provide a smooth moving image.

However, in a camera, if the exposure time is too short, there may be a shortage of exposure when an amount of light is small in an image capturing place, in other words, when an image is captured in a dark place. To avoid the shortage of exposure, the exposure time becomes long time in a dark place. Therefore, conventional cameras capture images by detecting external luminance and setting the exposure time so that a sufficient number of frames can be captured while avoiding shortage of exposure time.

Japanese Patent No. 3303643 is example of rerated art.

### SUMMARY

According to an aspect of the invention, a camera control apparatus which controls an exposure time of a camera that takes a moving image, the camera includes a memory for storing the moving image taken by the camera, an image capturing unit for capturing the moving image from the camera and storing the moving image into the memory, a first candidate generator for generating the first candidate of the exposure time on the basis of a speed of the movable body, a second candidate generator for generating a second candidate of the exposure time on the basis of the moving image stored in the memory, and, a setting unit for selecting a shorter time between the first candidate and the second candidate, and for setting the selected candidate as the exposure time.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram of a camera system according to a first embodiment;

FIG. 2 is a flowchart of vehicle speed capturing processing according to the first embodiment;

FIG. 3 is a diagram showing speed information stored in a RAM according to the first embodiment;

FIG. 4 is a flowchart of drive shift information update processing according to the first embodiment;

FIG. 5 is a diagram showing drive shift information stored in the RAM according to the first embodiment;

FIG. 6 is a flowchart of image capturing processing according to the first embodiment;

FIG. 7 is a flowchart of exposure time calculation processing according to the first embodiment;

FIG. 8 is an illustration showing a first exposure time candidate—speed correspondence table stored in the ROM according to the first embodiment;

FIG. 9 is a conceptual diagram showing a correspondence relationship between a speed of a vehicle and a first exposure time candidate of a camera according to the first embodiment;

FIG. 10 is an illustration of an exposure time adjustment rate—gradation information correspondence table according to the first embodiment;

FIG. 11 is a conceptual diagram showing a correspondence relationship between a speed of the vehicle and an exposure time of the camera;

FIG. 12 is a diagram showing exposure time information stored in the RAM according to the first embodiment;

FIG. 13 is a block diagram of a camera system according to a second embodiment;

FIG. 14 is a flowchart of image capturing processing according to the second embodiment;

FIG. 15 is a flowchart of exposure time calculation processing of a first exposure time candidate and the number of frames per second according to the second embodiment;

FIG. 16 is a flowchart of exposure time calculation processing according to the second embodiment;

FIG. 17 is a flowchart of exposure time synchronization processing according to the second embodiment;

FIG. 18 is a block diagram of a first example of a frame controller according to the second embodiment;

FIG. 19 is a block diagram of the first example of the frame controller according to the second embodiment;

FIG. 20 is an illustration of a basic structure of IEEE1394 Automotive;

FIG. 21 is an illustration of a write request packet of IEEE1394 Automotive; and

FIG. 22 is an illustration of a response packet of IEEE1394 Automotive.

### DESCRIPTION OF EMBODIMENTS

### First Embodiment

Hereinafter, a block diagram of a camera system according to a first embodiment will be described.

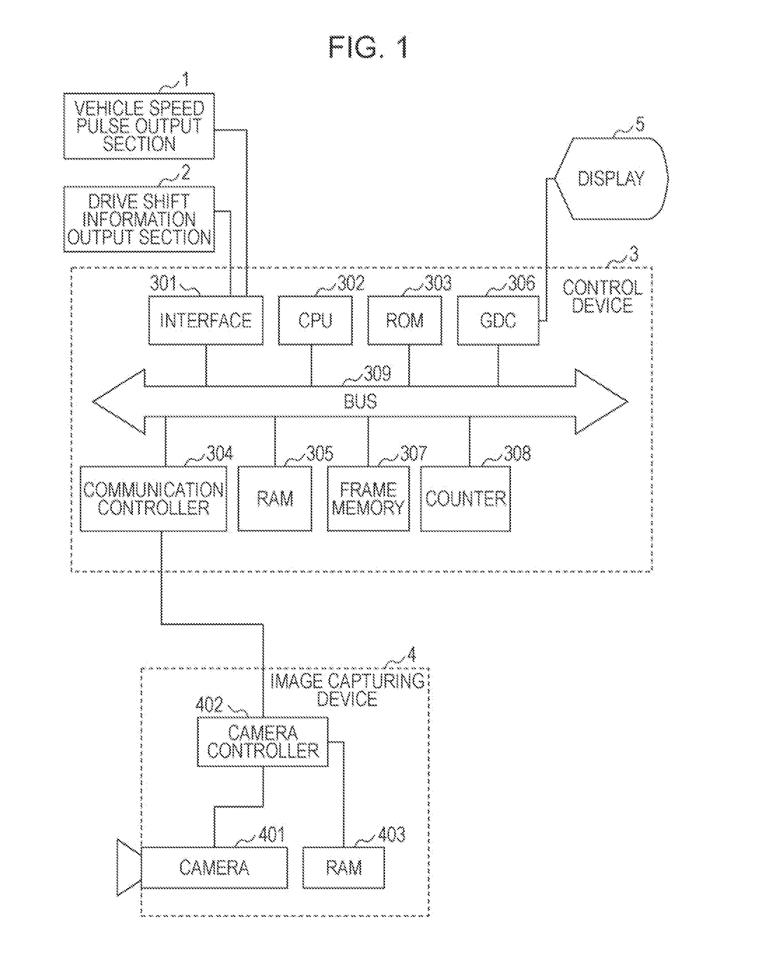

In the first embodiment, the camera system is installed in a vehicle that is a kind of a movable body. The vehicle 100 is not shown in FIG. 1.

In FIG. 1, reference numeral 1 denotes a vehicle speed pulse output section that outputs pulses at an interval corresponding to a rotation of a wheel of the vehicle 100. In this embodiment, for example, the vehicle speed pulse output section 1 is formed to output 2548 pulses every time the wheel rotates an amount corresponding to a 1 km drive of the vehicle. In other words, the vehicle speed pulse output section 1 is formed so that the faster the wheel rotates, the shorter the pulse interval is.

The vehicle speed pulse output section 1 is not limited to the above described vehicle speed pulse output section, but may be a component that outputs similar information related to a vehicle speed. For example, the vehicle speed pulse output section 1 may be a component that captures a simulated speed by using an acceleration sensor and outputs pluses corresponding to the speed.

Reference numeral 2 denotes a drive shift information output section that outputs drive shift information indicating a position of a shift lever not shown in FIG. 1. In this embodiment, the vehicle 100 has an automatic transmission. When the shift lever of the vehicle 100 is in the drive position that indicates a forward drive, D information is outputted, when the shift lever is in the reverse position, R information is outputted, when the shift lever is in the neutral position, N information is outputted, and when the shift lever is in the park position, P information is outputted. These signals and signal names are based on a representative automatic transmission, but they are not limited to the above. Other names and drive mechanisms having similar functions may be used.

Reference numeral 3 denotes a control device that generates state information such as driving and stopping as vehicle speed information and a vehicle state from the information outputted from the drive shift information output section 2, and outputs image information from an image capturing device 4 described below to a display 5.

The control device 3 includes an interface 301, a CPU (Central Processing Unit) 302, a ROM (Read Only Memory) 303, a communication controller 304, a RAM (Random Access Memory) 305, a frame memory that functions as an image storage means 307, a GDC (Graphic Display Controller) 306, and a counter 308. The above components perform data communication via a bus 309.

The interface 301 performs communication with the vehicle speed pulse output section 1 and the drive shift information output section 2. The ROM 303 stores a program executed by the CPU 302. Specifically, the CPU 302 performs various processing as the control device 3 by reading the program stored in the ROM 303.

The ROM 305 stores temporary data when the CPU 303 executes the program. The RAM 305 stores exposure time information of the image capturing device 4 described below, a vehicle speed pulse signal from the vehicle speed pulse output section 1, and drive shift information from the drive shift information output section 2.

The frame memory 307 temporarily stores frame data of an image transmitted from the image capturing device 4.

Further, the GDC 306 displays the image frame stored in the frame memory 307 on the display 5. In addition, the counter 308 is a counter that counts up by 1 count every 1/1024 second.

Although, for convenience of description, the counter is a hardware counter in the first embodiment, a pulse output unit that generates a pulse every 1/1024 second may be provided and the CPU 302 may count the pulse. In this case, the ROM 303 stores a program to cause the CPU 302 to perform the count processing, and the CPU 302 performs the count processing in accordance with the program.

In the first embodiment, the ROM 3 stores the program processed by the CPU 302. However, this is not limited to the above, but the control device 3 may include a hard disk and accumulate the program in the hard disk, and the CPU 302 may read the program from the hard disk and perform the processing. In the same way, a program stored in a storage medium such as a DVD, a CD, and a Blue-ray may be read by a corresponding reading device.

Reference numeral 4 denotes an image capturing device that is installed in the vehicle 100 and captures images outside the vehicle. In the first embodiment, the image capturing device 4 is installed in a front portion of the vehicle 100. Although the image capturing device 4 is installed in a front portion of the vehicle in this embodiment, the image capturing device 4 may be installed in another place depending on the shape of the vehicle in which the image capturing device 4 is installed and the purpose of the camera installation.

The image capturing device 4 includes a camera 401, a camera controller 402, and a RAM 403. Here, the camera 401 includes an imaging device (not shown in FIG. 1) such as a CCD (Charge Coupled Device) and a CMOS (Complementary Metal Oxide Semiconductor), and a lens (not shown in FIG. 1). The camera 401 captures an image on the basis of control of the camera controller 402 and outputs digital data of the captured image.

The camera controller 402 can communicate with the control device 3. The camera controller 402 stores exposure time information captured from the control device in the RAM 403 by communication with the control device. Also, the camera controller 402 controls exposure time of the camera 401 on the basis of the exposure time information stored in the RAM 403, and transmits the captured image data outputted from the camera 401 to the control device 3.

The communication between the control device 3 and the image capturing device 4 may be communication using a transmission path based on the IEEE1394 Automotive standard. In the first embodiment, the image captured by the camera 401 is digital image data having 256 gradations from 0 to 255 for each pixel. It is indicated that the smaller the gradation value is, the darker the pixel is. Although color digital image data generally includes gradations in each of red, blue, and green that are three primary colors of light, for ease of description, the first embodiment will be described on the assumption that each pixel has only 256 gradations. However, it is possible to use gradation information of one color of the color image data, for example, gradation information of red, as gradation information of the first embodiment. Of course, it is possible to calculate an average of each color for each pixel, and use the average as the gradation information of the first embodiment.

Hereinafter, an operation of the camera system according to the first embodiment described above will be described.

Although details are not described, in this system, the CPU 302 executes an operating system program stored in the ROM 303. On this operating system, multi-tasking is possible, and the CPU 302 can perform each processing described below apparently in parallel. Each processing is performed by the CPU 302 executing the processing program stored in the ROM 303.

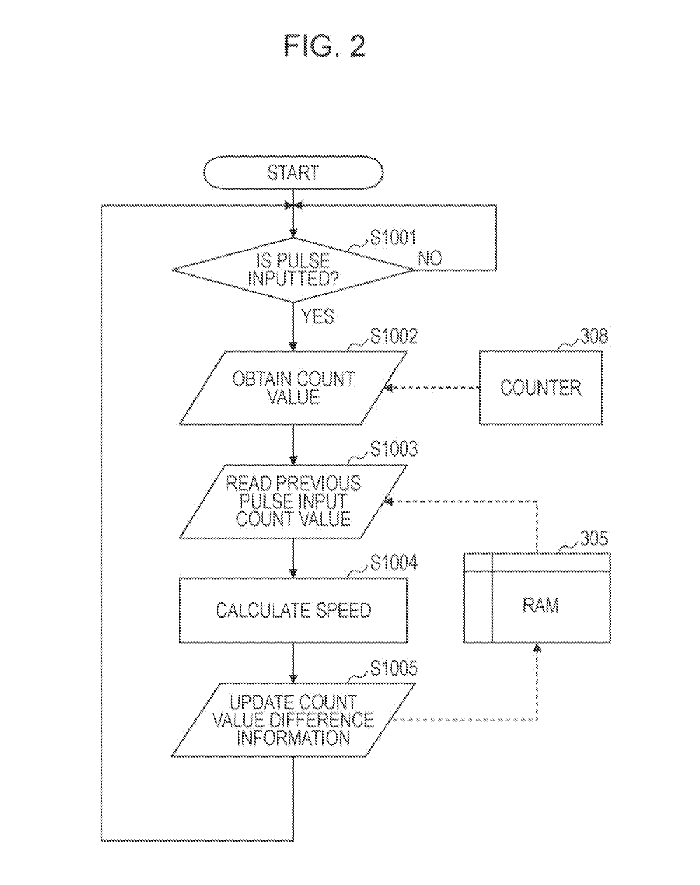

Further, in the description below, when it is described that the CPU 302 captures and stores data, the CPU 302 temporarily stores the data in the RAM 305. (For example, vehicle speed capturing processing, image capturing processing, first candidate generating processing, second candidate generating process, and updating processing described later).

[Vehicle speed capturing processing] First, the vehicle speed capturing processing will be described with reference to a flowchart of FIG. 2.

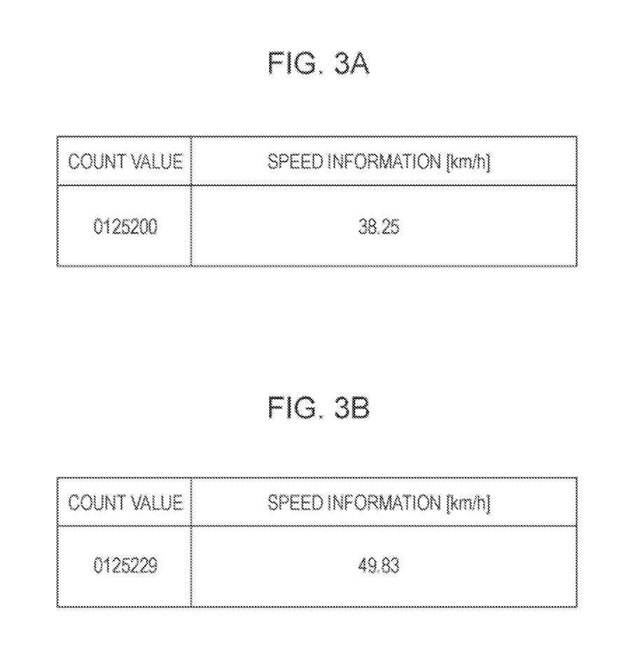

As shown in FIG. 3A, a table 10001 showing a count value and speed information is stored in the RAM 305. Writing or reading the count value or the speed information to or from the RAM is performed by referring to or updating the table 10001 in the RAM 305.

First, the CPU 302 checks whether a pulse from the vehicle speed pulse output section 1 is inputted into the interface 301 (S1001). If the pulse is not inputted, the CPU 302 returns to the processing of S1001. If the CPU 302 determines that the pulse is inputted in S1001, the CPU 302 captures a count value from the counter 308 (S1002). Here, the count value of the counter 308 is “125228”, and the CPU 302 captures this value.

Next, the CPU 302 reads the count value stored in the RAM 305 (S1003). Here, as shown in FIG. 3A, the count value “125200” is stored in the RAM 305, and the CPU 302 reads the count value “125200”.

Next, the CPU 302 performs speed calculation on the basis of a difference between the count values (S1004). Specifically, first, the CPU 302 performs processing for capturing a difference of the value read from the RAM 305 from the count value captured from the counter 308. As described above, the count value captured from the counter 308 is “125229” and the count value read from the RAM 305 is “1258200”, so that the value (hereinafter referred to as difference value D) outputted from the CPU 302 after performing the processing for capturing the difference is “29”.

Next, the CPU 302 performs a calculation based on the equation below, and calculates a speed (km/h) as the speed of the vehicle 100.

The speed S of the vehicle 100 is calculated by the following equation:

S [km/h]=m [m]/(D/1024) [sec]*3.6 [km/h]/[m/sec]

m: a distance [m] by which the vehicle 100 advances from when a pulse is outputted from the vehicle speed pulse output section 1 to when the next pulse is outputted

D: the difference value

The constant 3.6 is a constant for converting the speed [m/sec] into the speed [km/h] because m is [m] or a meter unit and (D/1024) is [sec] or a second unit.

As described above, the vehicle speed pulse output section 1 is formed to output 2548 pulses every time the wheel rotates an amount corresponding to a 1 km drive of the vehicle. Therefore, m is 0.392 [m] here.

As a result, the speed S of the vehicle 100 calculated by the CPU 302 is 49.83 [m/h].

Next, as shown in FIG. 3B, the CPU 302 updates the speed information stored in the RAM 305 with the vehicle speed “49.83” captured by the processing in S1004. Also, as shown in FIG. 3B, the CPU 302 updates the count value stored in the RAM 305 with the count value “0125229” of the counter 308 captured by the processing in S1002, and returns to the processing of S1001 (S1005).

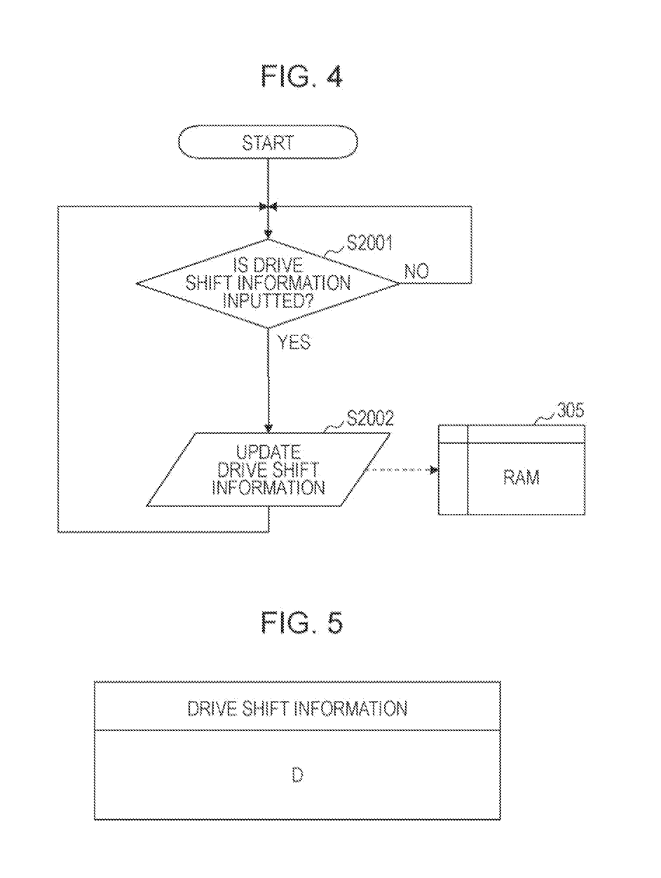

In the first embodiment, the speed of the vehicle 100 is captured from the interval of the pulses outputted from the vehicle speed pulse output section 1. Although, in the first embodiment, the driving speed of the vehicle 100 is captured every time a pulse is received from the vehicle speed pulse output section 1, the speed calculation processing may be performed when a plurality of pulses are received. In this case, the speed S of the vehicle 100 can be calculated by replacing the value of m in the processing of S1004 by a distance by which the vehicle 100 advances by when a plurality of pulses are outputted from the vehicle speed pulse output section 1. In the first embodiment, once the driving speed of the vehicle 100 is calculated, the speed of the vehicle 100 is updated with the calculated driving speed. However, it is possible to perform the same calculation several times and update the speed of the vehicle 100 with an average of the calculated driving speeds.

[Drive shift information update processing] Next, drive shift information update processing will be described with reference to a flowchart of FIG. 4. As shown in FIG. 5, drive information 10002 is stored in the RAM 305.

First, the CPU 302 checks whether the drive shift information from the drive shift information output section 2 is inputted into the interface 301 (S2001). If the drive shift information is not inputted, the CPU 302 returns to the processing of S2001.

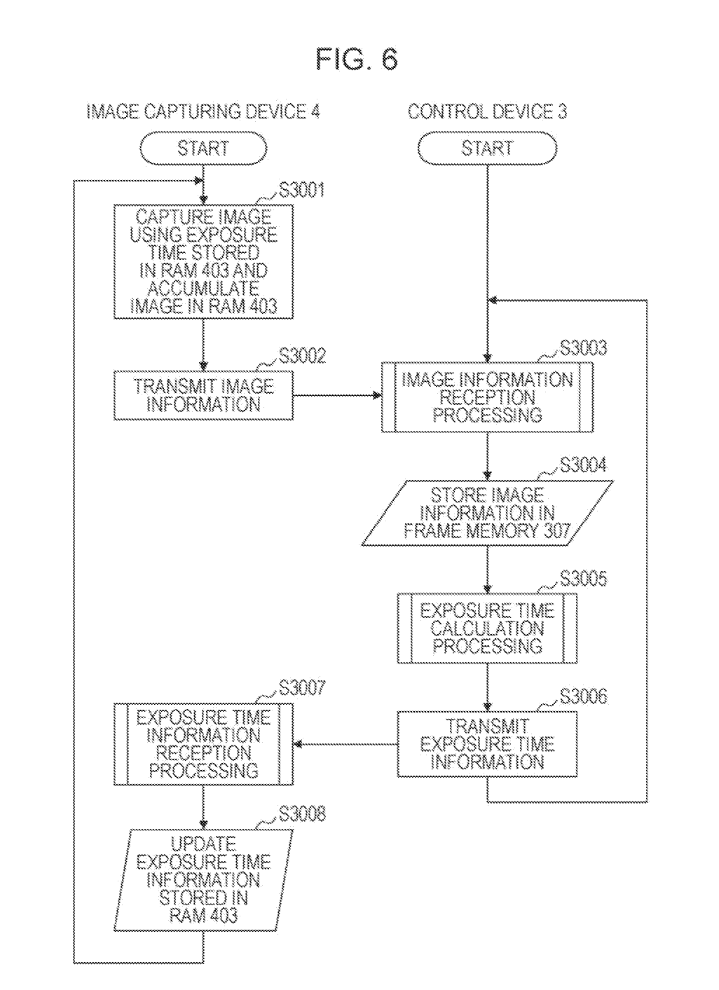

If the drive shift information is inputted in S2001, the CPU 302 updates the drive shift information stored in the RAM 305 with the inputted drive shift information. FIG. 5 shows a state in which the D information indicating that the drive shift is in drive is inputted in S2001 and the CPU 302 updates the drive shift information in S2002.

[Image capturing processing] Image capturing processing using the image capturing device 4 will be described with reference to a sequence chart of FIG. 6. In the first embodiment, the ROM 403 stores a frame image capturing time of the camera 401.

First, the camera controller 402 of the image capturing device 4 performs image capturing using the camera 401 with an exposure time based on the exposure time information stored in the RAM 403. Then, the camera controller 402 accumulates image data captured by the camera 401 in the RAM 403 (S3001).

Then, the camera controller 402 transmits the image information accumulated in the RAM 403 to the control device 3 (S3002).

The CPU 302 in the control device 3 receives the image information via the communication controller 304 (S3003) and stores the image information in the frame memory 307 (S3004). In the first embodiment, in the reception processing in S3003, the CPU 302 waits for the arrival of the image information from the communication controller 304, and when the image information arrives, the CPU 302 proceeds to the processing of S3004.

Next, the CPU 302 calculates the exposure time (S3005). This processing will be explained in detail in “Exposure time calculation processing” described below.

When the calculation processing of the exposure time is completed, the CPU 302 controls the communication controller 304 to transmit the exposure time information outputted as a result of the calculation processing to the image capturing device 4 (S3006).

The image information stored in the frame memory 307 by the processing of S3004 is displayed on the display by the GDC 306 independently from the processing of the CPU 302.

When the camera controller 402 of the image capturing device 4 receives the exposure time information from the control device 3 (S3007), the camera controller 402 updates the exposure time in the RAM 403 with the exposure time information received from the control device 3 (3008).

When the processing of S3008 is completed, the camera controller 402 returns to S3001 and performs the next image capturing processing.

In the first embodiment, in the processing of the image capturing device 4, the exposure time of the image information that has been captured is calculated, and thereafter, the next image capturing is performed. However, the camera controller 402 may perform the processing of S3001 to S 3002 and the processing of S3007 to S3008 in parallel. In this case, when the processing of S3002 is completed, the camera controller 402 moves to the processing of S3001, and individually from the above, when the processing of S3008 is completed, the camera controller 402 moves to the processing of S3007. In this way, the camera controller 402 can start the next image capturing processing immediately after the transmission of the image information is completed.

Or, the camera controller 402 may usually perform the processing of S3001 when the processing of S3002 is completed, and the camera controller 402 performs the processing of S3007 to S3008 by an interrupt when communication is performed from the control device 3. Specifically, a reception section for receiving information from the control device 3 is provided in the image capturing device 4, and when the reception section receives information from the control device 3, the reception section outputs an interrupt signal to the camera controller 402. The camera controller 402 performs the processing of S3007 to S 3008 in accordance with the interrupt signal.

Further, when the camera controller 402 inputs the exposure time information into the camera 401, the camera 401 performs image capturing using an exposure time corresponding to the exposure time information, and when the camera controller 402 transmits the next exposure time to the camera 401 after the processing of S3001, the camera 401 can start the next image capturing. In this way, the camera controller 402 can start the next image capturing processing (processing of S3001) in parallel with the transmission of the image information in the RAM 403.

[Exposure time calculation processing] Next, exposure time calculation processing (processing of S3005) of the above image capturing processing will be described.

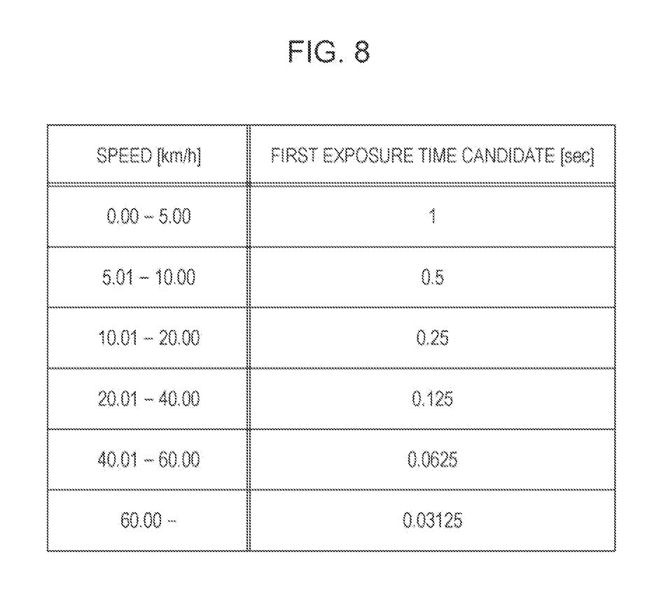

In the first embodiment, the ROM 303 stores “first exposure time candidate—speed correspondence table 10” shown in FIG. 8 and “exposure time adjustment rate—gradation information correspondence table 11”. The RAM 305 includes an area where the exposure time information calculated by this exposure time calculation processing is stored.

Among them, the first exposure time candidate—speed correspondence table 10 will be complementarily described.

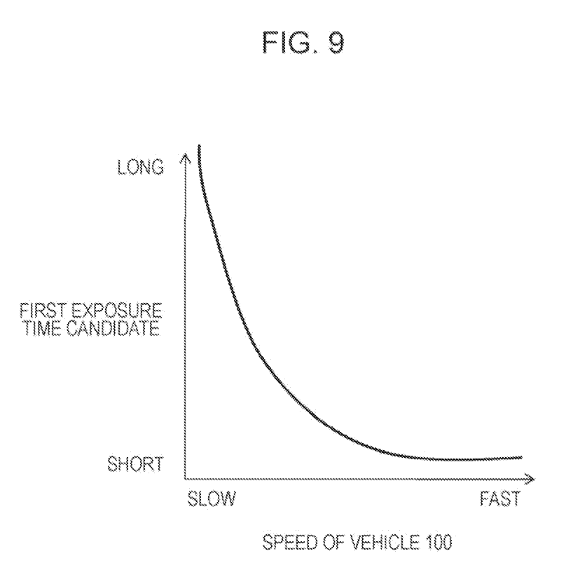

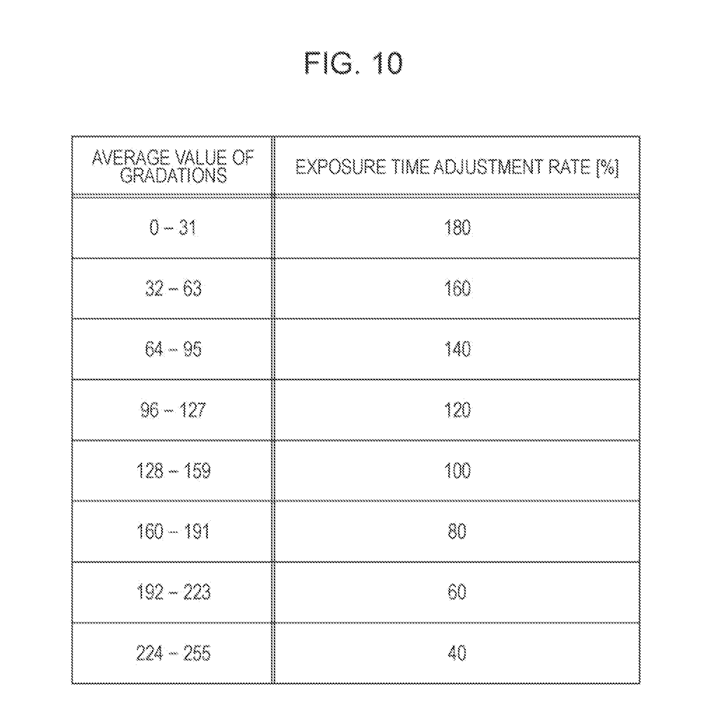

The first exposure time candidate of the first exposure time candidate—speed correspondence table 10 indicates a first exposure time candidate of the camera 401, and the speed indicates the speed of the vehicle 100. As shown in the conceptual diagram 10003 of FIG. 9, it is an object of the first embodiment to perform processing so that as the speed of the vehicle 100 increases, the first exposure time candidate is shortened. Therefore, the first exposure time candidate—speed correspondence table 10 is a table in which the faster the speed is, the shorter the first exposure time candidate is.

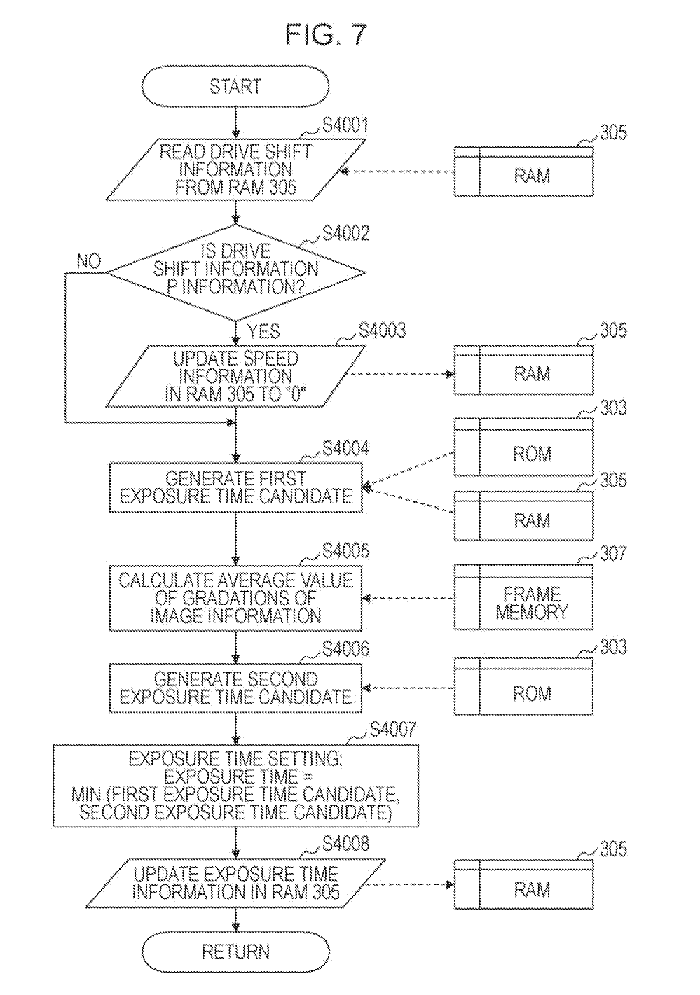

The exposure time adjustment rate—gradation information correspondence table 11 is a table used for selecting a second exposure time candidate on the basis of an average gradation of the image data stored in the frame memory 307 in the processing of the CPU 302 described below. The exposure time adjustment rate here indicates an adjustment rate with respect to the current exposure time. For example, when the current exposure time is 0.5 seconds and the exposure time adjustment rate is 120%, the second exposure time candidate is 0.5×1.2=0.6 seconds. As shown in the conceptual diagram 10004 of FIG. 11, to make the image data have an appropriate brightness, if the image is brighter than the appropriate brightness, the exposure time of the camera 401 is shortened, and if the image is darker than the appropriate brightness, the exposure time of the camera 401 is lengthened. As described above, the smaller the value of gradation information is, the darker the image is. Therefore, in the exposure time adjustment rate—gradation information correspondence table 11, when the value is smaller than the range of appropriate brightness 128 to 159, an exposure time adjustment rate (greater than 100%) to lengthen the exposure time is assigned, and when the value is greater than the range, an exposure time adjustment rate (smaller than 100%) to shorten the exposure time is assigned. Hereinafter, the exposure time calculation processing (processing of S3005) will be described with reference to a flowchart of FIG. 7.

First, the CPU 302 reads the drive shift information stored in the RAM 305 (S4001). The drive shift information is outputted from the drive shift information output section 2 and stored in the RAM 305 by the CPU 302 in the drive shift information update processing described above.

Here, it is checked whether the drive shift information is “P” information, and when the drive shift information is “P” information, the speed information stored in the RAM 305 is updated to 0 (S4002, S4003). As described above, “P” is the information indicating that the shift lever is in the parking position. When the shift lever is in the parking position, the vehicle is parked, and the wheels of the vehicle 100 are not rotated (in many vehicles, the brake is locked). On the other hand, the vehicle speed pulse output section 1 may output a pulse signal even when the vehicle is stopped due to the circuit or the mechanism thereof. Therefore, it is desirable that the speed is set to “0” regardless of whether the pulse is outputted from the vehicle speed pulse output section 1 if there is the “P” information indicating that the vehicle is actually stopped. Therefore, in the first embodiment, the processing from S4001 to S4003 is performed. The processing from S4002 to S4003 is to check whether the vehicle is stopped, and if there is other processing to check whether the vehicle is stopped, the other processing may be used. If the speed calculated on the basis of the output from the vehicle speed pulse output section 1 is not so different from “0” when the vehicle is stopped, the processing from S4001 to S4003 need not be processed.

Next, the CPU 302 reads the speed information stored in the RAM 305 by the [vehicle speed capturing processing], refers to the first exposure time candidate—speed correspondence table 10 stored in the ROM 303, and generates the first exposure time candidate corresponding to the speed information (S4004, as the first candidate generating process). For example, when the speed information after the processing of S4001 to S4003 is “49.83” [km/h] as shown in FIG. 3B, the CPU 302 reads the speed information “49.83” from the RAM 305, and determines the first exposure time candidate “0.0625” corresponding to the speed in the first exposure time candidate—speed correspondence table 10.

Next, the CPU 302 calculates an average value of gradations of the image data stored in the frame memory 307 by the image capturing processing described above (S4005, as the second candidate generating process). As described in the above image capturing processing, the image data stored in the frame memory 307 is the image data captured by the camera 401. Also as describe above, each pixel of the image data has gradation information represented by values from 0 (dark) to 255 (bright). The CPU 302 performs processing for calculating the average value of the gradations of the image data by reading the gradation information of each pixel of the image data stored in the frame memory 307 and capturing the average value of the gradation information. In this description, the CPU 302 calculates the average value of the gradations to be “73”. Although, in this embodiment, the average value is used, it is possible to perform processing for multiplying an appropriate coefficient according to actual human visual perception.

Next, the CPU 302 refers to the exposure time adjustment rate—gradation information correspondence table 11, and determines an adjustment amount of the exposure time corresponding to the average value of the gradations captured in S4005. Then, the CPU 302 generates the second exposure time candidate by multiplying the extracted value of the exposure time information stored in the RAM 305 by the adjustment amount of the exposure time (S4006).

The processing of S4006 will be illustrated using an example in which in S4005, the CPU 302 calculates the average value of the gradations to be “73” as described above, and in the previous exposure time calculation processing, the exposure time is calculated to be “0.11” and the exposure time information 10005 is stored in the RAM 305. First, the CPU 302 refers to the exposure time adjustment rate—gradation information correspondence table 11, and selects the adjustment amount of the exposure time “140” [%] corresponding to the average value of the gradations “76”. Next, the CPU 302 generates the second exposure time candidate “0.154” [sec] by calculating a 140 [%] value of the value of the exposure time “0.11” stored in the RAM 305.

Next, the CPU 302 compares the first exposure time candidate captured in S4005 and the second exposure time candidate generated in S4006, and selects the smaller value, in other words, the shorter exposure time, as the exposure time (S4007). In the example described above, the first exposure time candidate captured in S4005 is “0.0625” [sec] and the second exposure time candidate generated in S4006 is “0.154” [sec], so that the smaller value is “0.0625” [sec]. Therefore, the CPU 302 selects the smaller value “0.0625” [sec] as the exposure time information 10005.

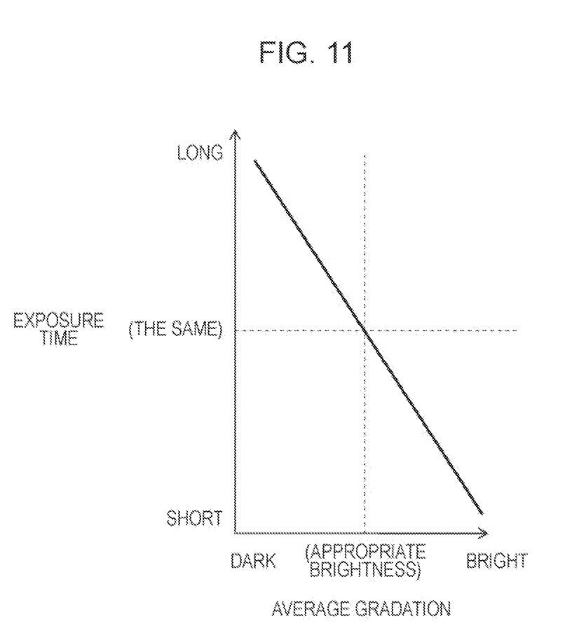

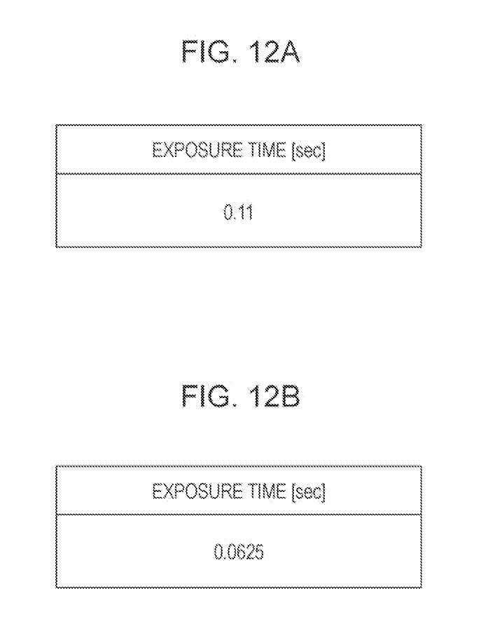

Thereafter, as shown in FIG. 12B, the CPU 302 updates the exposure time information 10005 in the RAM 305 with the new exposure time “0.0625” [sec] selected in S4007 (as the updating processing), and moves to the next processing (S3006 in the image capturing processing).

As described above, the camera system according to the first embodiment employs the second exposure time candidate that realizes an appropriate brightness as a new exposure time when the current exposure time is shorter than the first exposure time candidate. When the current exposure time is longer than or equal to the first exposure time candidate, the exposure time is not lengthened from the current exposure time even if the image is darker than a predetermined brightness.

When the speed is slow, the first exposure time candidate is set to be long, so that image data having the brightness that can be easily seen by a driver can be actually captured even if the update of the image data is slow. In other words, when the vehicle is driven in slow speed or stopped, it is possible to capture a detailed image even in a dark place.

When the vehicle 100 is driven in slow speed or stopped, the driver of the vehicle 100 often checks the width of the vehicle, the backward area of the vehicle, and objects (person, obstacle, and the like) around the vehicle. When doing such actions, the diver often drives the vehicle seeing the image information captured by the image capturing device and displayed on the display 5. As described above, the camera system according to the first embodiment does not capture image with insufficient exposure even in a dark place when the vehicle is driven in slow speed. Therefore, it is possible to provide an image that can be easily seen by the driver of the vehicle 100 when the vehicle is driven in slow speed or stopped.

When the driver is driving the vehicle 100 in a normal driving mode or at a somewhat high speed, the driver rarely sees the image displayed on the camera system, and the driver usually drives the vehicle while watching outside the vehicle. In recent years, the display 5 is often arranged in a position in view of the driver when the driver is driving the vehicle so that the driver can see the display without largely changing the line of sight when the driver is driving while watching outside the vehicle. In such a situation, if an image that is similar to the outside view directly seen by the driver and has a low frame rate is displayed on the display 5, the driver may have a feeling of strangeness and the driving may be difficult. Therefore, as in the first embodiment, by shortening the first exposure time candidate when the speed of the vehicle 100 increases, it is possible to increase the update frequency of the image in the normal driving mode in which the driver usually drives the vehicle while watching outside vehicle. Therefore, it is possible to provide an image causing a less feeling of strangeness for the driver.

As described above, the camera system according to the first embodiment can provide image data with a quality and the update frequency which is used by the driver of the vehicle 100 in accordance with a driving state.

In the first embodiment, processing for comparing the first exposure time candidate and the second exposure time candidate captured from the gradation information of the image data is always performed. However, when a clear image can be captured even if the exposure time is short, for example, during daylight hours, the limitation of the first exposure time candidate need not be performed. For example, it is possible to provide an illumination sensor connected to the interface 301 which detects the illuminance outside the vehicle and perform the limitation of the first exposure time candidate when the illuminance is lower than a predetermined value.

Although, in the first embodiment, the second exposure time candidate is selected on the basis of gradation information of the image captured by the camera 401, the selection method is not limited to this. For example, it is possible to provide an illumination sensor that detects the illuminance in the image capturing direction of the camera 401 and select the second exposure time candidate on the basis of illuminance information of the illumination sensor. However, it is needless to say that, when the exposure time is selected on the basis of the gradation information of the image captured by the camera 401 as in the first embodiment, an appropriate exposure time can be selected even if the illumination sensor is not provided.

### Second Embodiment

In the first embodiment, there is one image capturing device 4. However, camera systems in recent years may include a plurality of image capturing devices and generate one image data by combining images captured by these image capturing devices. For example, it is considered that image capturing devices are attached on the front, rear, left side, and right side of the vehicle so as to generate a virtual image by which all areas surrounding the vehicle can be seen at the same time.

If the processing of the first embodiment is performed on each image capturing device in such a camera system that performs the above processing, a different exposure time is set for each image capturing device and image is transmitted at an interval of the exposure time. Therefore, the number of frames transmitted from each image capturing device per unit time is different from each other. In the first place, if image capturing is performed by each image capturing device individually, it is difficult to synchronize the image capturing timings.

Considering the above, in the second embodiment, image capturing can be performed in accordance with a driving state of the vehicle as in the first embodiment even in a system in which image data captured by a plurality of image capturing devices are combined.

Specifically, in the second embodiment, the first exposure time candidate and an image capturing interval are set in accordance with a transmission timing of a camera that is assumed to correspond to an image watched by the driver depending on the driving state of the vehicle.

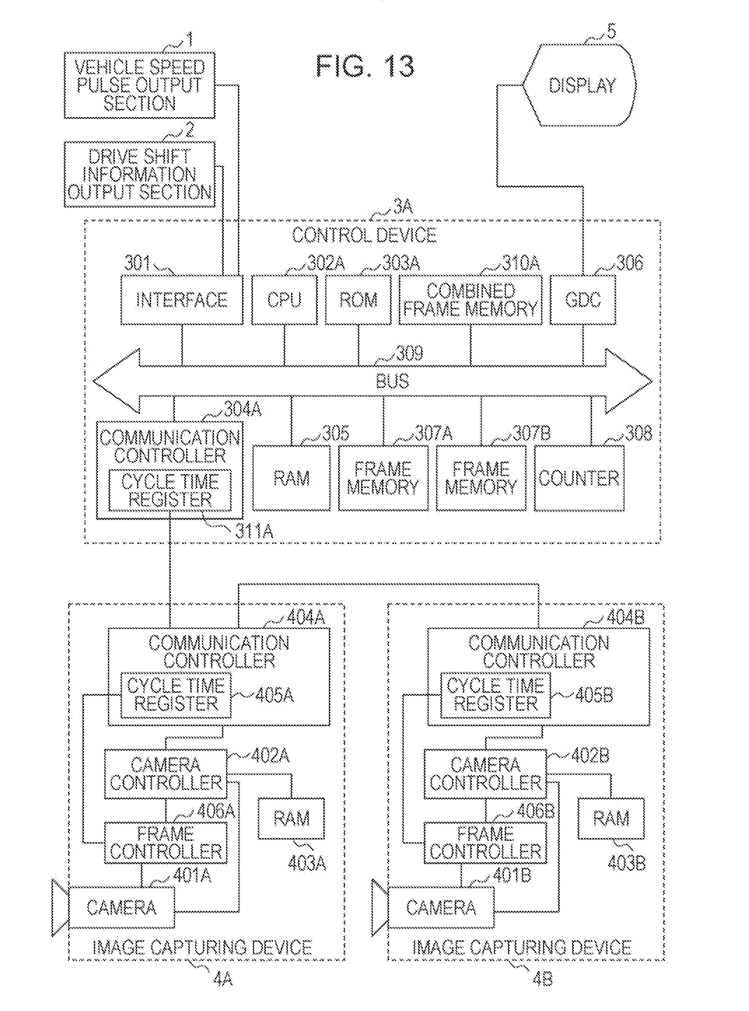

First, a configuration of the camera system according to the second embodiment will be described with reference to FIG. 13.

In FIG. 13, constituent elements to which [A] or [B] is not added are the same constituent elements as those in the first embodiment, so that detailed description will be omitted.

In the second embodiment, a case in which two cameras, which are image capturing devices 4A and 4B, are installed in the vehicle 100 not shown in FIG. 13 will be described.

The control device 3A of the second embodiment performs processing for capturing image data from the image capturing devices 4A and 4B and combining the image data, and further performs processing for displaying the combined image data on the display 5. Reference numeral 302A in the control device 3A denotes a CPU, and the CPU performs various processing of the second embodiment described below by executing various programs stored in a ROM 303A.

The control device 3A includes a frame memory 307A storing image data from the image capturing device 4A and a frame memory 307B storing image data from the image capturing device 4B. In addition, the control device 3A includes a combined frame memory 310A storing image data formed by combining the image data stored in the frame memory 307A and the image data stored in the frame memory 307B. Further, a communication controller 304A in the control device 3A can perform communication based on the IEEE1394 Automotive standard. The communication controller 304A includes a cycle time register 310A.

Next, reference numeral 401A in the image capturing device 4A and reference numeral 401B in the image capturing device 4B respectively denote cameras for capturing images outside the vehicle. Reference numerals 402A and 402B denote camera controllers for performing various controls of the cameras 401A and 401B, and the camera controllers 402A and 402B also perform processing for setting the exposure time in the cameras 401A and 401B respectively in accordance with the exposure time stored in RAMs 403A and 403B. Further, reference numerals 404A and 404B are communication controllers communicating with the control device 3A and the other image capturing devices 4B and 4A respectively. In the same way as the communication controller 304A in the control device 3A, the communication controllers 404A and 404B can perform communication based on the IEEE1394 Automotive standard. The communication controller 404A includes a cycle time register 405A and the communication controller 404B includes a cycle time register 405B.

Here, the communication controllers 304A, 404A, and 404B will be complementarily described.

As described above, the communication controllers 304A, 404A, and 404B can perform communication based on the IEEE1394 Automotive standard. As shown in FIG. 13, the communication controllers 304A and 404A are physically connected to each other, the communication controllers 404A and 404B are physically connected to each other, and the communication controllers 304A and 404B can communicate with each other via the communication controller 404A. Hereinafter, the communication between the communication controllers 304A and 404B is assumed to be performed via the communication controller 404A.

The communication controllers 304A, 404A, and 404B respectively have a clock generator (not shown in FIG. 13) generating the same clock. The cycle time registers 311A, 405A, and 405B store a count value and count up the count value in accordance with a clock from the respective clock generators. The communication controllers communicate with each other at the start-up of the devices or at periodic timings so as to synchronize these count values so that the count values are the same at the same timing.

Next, reference numerals 406A and 406B are frame controllers that issue an instruction for starting image capturing on the basis of image capturing start timings that are transmitted from the control device 3A and received by the camera controllers 402A and 402B and values of the cycle time registers 405A and 406B.

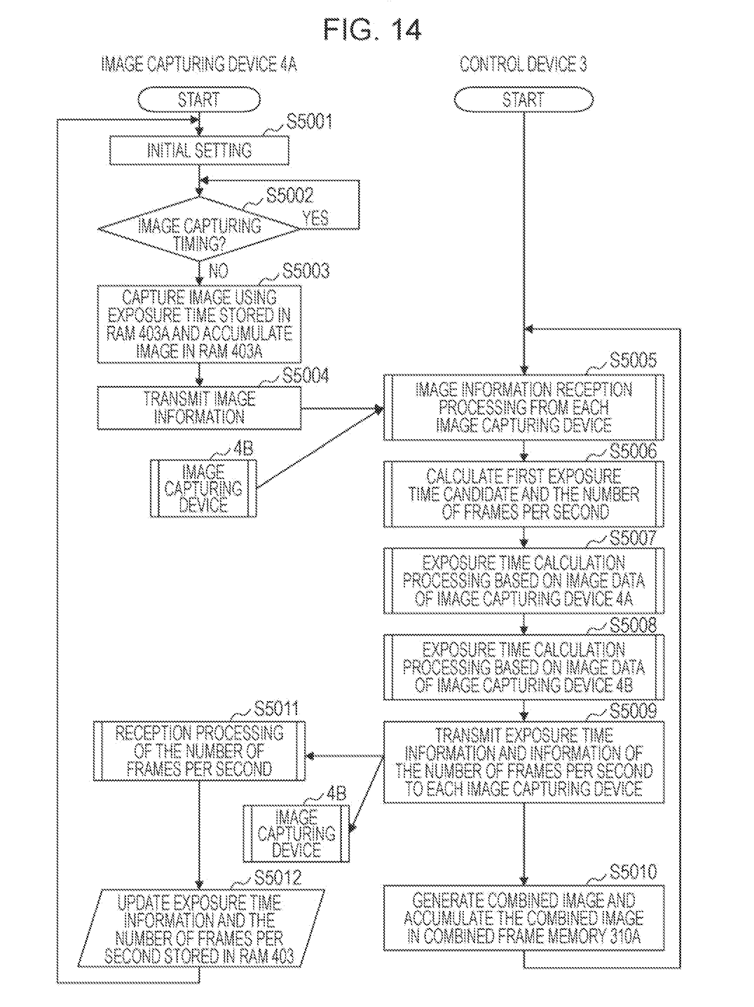

Hereinafter, an operation of the camera system according to the second embodiment having the above configuration will be described.

[Vehicle speed capturing processing] and [Drive shift information update processing], [Vehicle speed capturing processing] and [Drive shift information update processing] in the second embodiment are the same as those in the first embodiment, which are realized by the CPU 302A executing the program stored in the ROM 303A, so that description will be omitted.

[Image capturing processing] Next, image capturing processing according to the second embodiment will be described with reference to a flowchart of FIG. 14.

Since the image capturing device 4A and the image capturing device 4B perform the same processing, in the description of this processing, processing of the image capturing device 4A will be mainly described, and the image capturing device 4B is assumed to perform the same processing as that of the image capturing device 4A.

First, the camera controller 402A transmits the exposure time information stored in the RAM 403A to the camera 401A. Also, the camera controller 402A transmits the number of frames per second stored in the RAM 403A to the frame controller 406A (S5001).

The frame controller 406A compares the timing of the cycle time register 405A and synchronization timing information transmitted from the camera controller 402A, and outputs an image capturing start signal to the camera 401A when an image capturing timing is detected (S5002).

The camera 401A that receives the image capturing start signal performs image capturing based on the exposure time transmitted from the camera controller. The camera controller 402A accumulates the captured image data in the RAM 403 (S5003).

Next, the camera controller 402A controls the communication controller 405A to transmit the image data accumulated in the RAM 403 to the control device 3 (S5004).

The control device 3A receives the image data from each of the image capturing device 4A and 4B via the communication controller 304A, and stores the image data in the frame memory 307A and 307B respectively (S5005).

Next, the CPU 302A calculates the first exposure time candidate and a frame interval on the basis of the image data accumulated in the frame memories 307A and 307B (S5006).

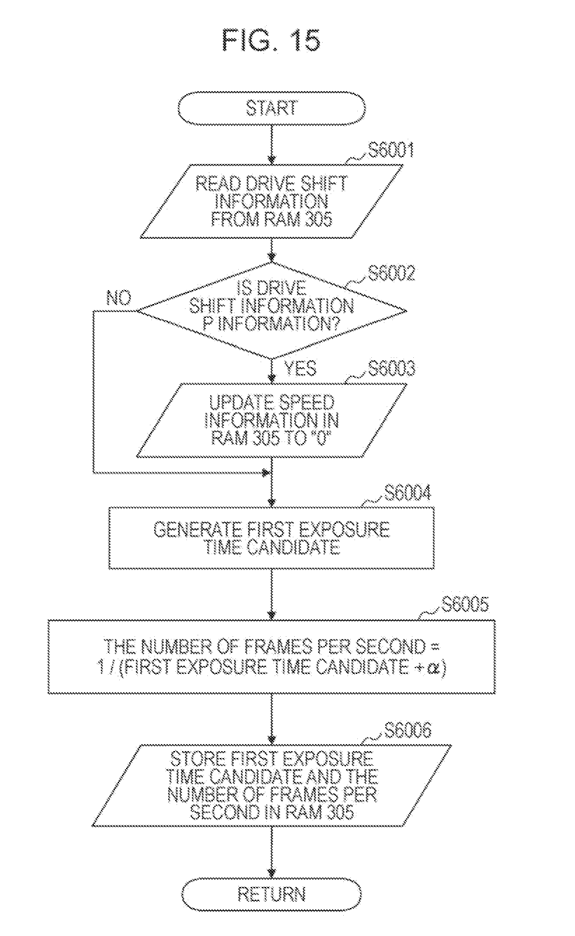

The processing of S5006 will be complementarily described with reference to a flowchart of FIG. 15. First, the CPU 302A performs the same processing as the processing in which the first exposure time candidate is captured in S4005 of the “Exposure time calculation processing” in the first embodiment. Specifically, the CPU 302A reads the speed information stored in the RAM 305 (S6001), and when the drive shift information stored in the RAM 305 is “P”, the CPU 302A updates the speed information in the RAM 305 to “0” (S6002, S6003). Then, the CPU 302A refers to the first exposure time candidate—speed correspondence table 10 stored in the ROM 303, and determines the first exposure time candidate corresponding to the speed information (S6004).

Next, the CPU 302A calculates the number of frames per second (S6005). Specifically, the CPU 302A performs the following processing:

The number of frames per second=1/(the first exposure time candidate+α)

Then, the CPU 302A stores the information of the first exposure time candidate and the number of frames per second in the RAM 305, and proceeds to the next processing (processing of S5007 in FIG. 14) (S6006).

In the above processing, the specified value α is a margin of time considered from processing time of each device.

Next, the CPU 302A performs the exposure time calculation processing based on the image data in the frame memory 307A, that is, the image data of the image capturing device 4A (S5007).

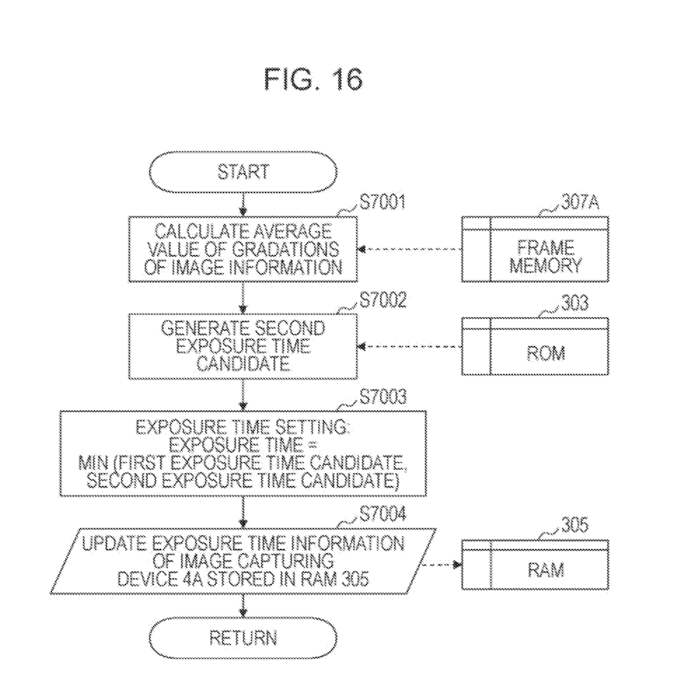

This processing will be described with reference to a flowchart of FIG. 16. First, the CPU 302A captures the image information captured from the image capturing device 4A from the frame memory 307A (S7001). Next, the CPU 302A determines the second exposure time candidate (S7002). This processing is the same as the processing in S4006 in the first embodiment. Next, the CPU 302A selects the shorter one between the first exposure time candidate captured in S5006 and the second exposure time candidate determined in S7002, and determines that the shorter one is used as the exposure time (S7003). Then, the CPU 302A updates the exposure time information of the image capturing device 4A stored in the RAM 305 with the exposure time information determined in S7003.

When the exposure time calculation processing for the image capturing device 4A is completed, regarding the image capturing device 4B, the CPU 302A updates the exposure time information of the image capturing device 4B by using the first exposure time candidate stored in S5006 and the second exposure time candidate determined on the basis of the average value of the gradations in the frame memory 307B of the image capturing device 4B in S7004 (S5008). The processing of S5008 is the same as the processing of S5007 except for that the CPU 302A refers to the frame memory 307B in S7001 and that the CPU 302A updates the exposure time information of the image capturing device 4B stored in the RAM 305 in S7004.

Next, the CPU 302A transmits the calculated number of frames per second and the exposure time information of the image capturing device 4A to the image capturing device 4A. Similarly, the CPU 302A transmits the calculated number of frames per second and the exposure time information of the image capturing device 4B to the image capturing device 4B (S5009).

Next, the CPU 302A combines the image data stored in the frame memories 307A and 307B and accumulates the combined image data in the combined frame memory 310A, and then the CPU 302A moves to the processing of S5005 (S5010). The accumulated image data is displayed on the display by the GDC 306. The processing of S5010 is not necessarily need to be after S5009, but may be between S5006 and S5009.

When the camera controller 402A in the image capturing device 4A receives the number of frames per second and the exposure time information from the control device 3A (S5011), the camera controller 402A updates the above information stored in RAM 403A, and moves to the processing of S5001 (S5012).

Also, the image capturing device 4B performs the same processing.

In the camera system according to the second embodiment, the control device 3 transmits the same number of frames per second to the image capturing devices 4A and 4B. Based on this, the image capturing devices 4A and 4B can perform image capturing with the same number of frames per unit time. As described above, the cycle time registers 405A and 405B of the communication controllers 404A and 404B in the image capturing devices 4A and 4B synchronize with each other, and indicate the same value at the same timing. In other words, the image capturing devices 4A and 4B perform image capturing at the same timing.

In the second embodiment, although the image capturing devices 4A and 4B use the same first exposure time candidate, the exposure time is calculated by each image capturing device individually. Based on this, each image capturing device can individually capture an image with an appropriate brightness in accordance with a driving state, and provide an image that can be easily seen by the driver.

However, when such processing is performed, the illuminance of an object of each image capturing device may be largely different from each other. For example, when considering a vehicle driving in the night, the front of the vehicle is lighted up by headlights. However the headlights hardly light up side areas of the vehicle, so that objects in the side areas are dark.

In such a situation, when creating a combined image, an unevenness of brightness, so to speak, a step of brightness is generated near the boundary of the images, so that an unnaturally combined image is created.

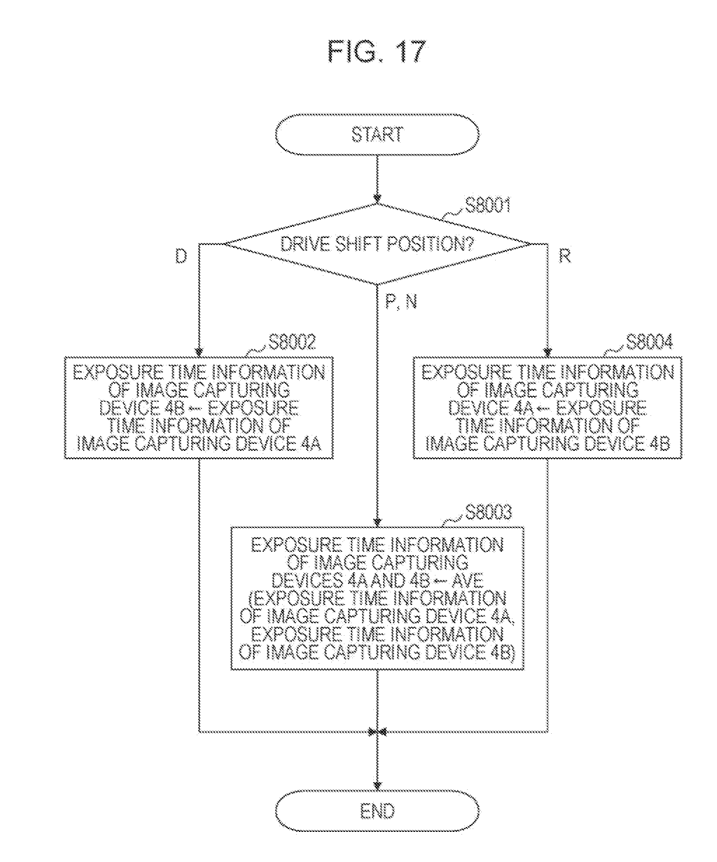

To avoid the above problem, the CPU 302A may perform the processing shown in FIG. 17 after the processing of S5008. In the description here, it is assumed that the image capturing device 4A captures images in the front area of the vehicle 100, and the image capturing device 4B captures images in the rear area of the vehicle 100.

First, the CPU 302A checks the drive shift information stored in the RAM 305 (S8001). Here, when the drive shift information is “D”, which indicates forward driving, the CPU 302A performs processing for updating the exposure time information of the image capturing device 4B with the exposure time information of the image capturing device 4A (S8002). When the drive shift information is “R”, which indicates backward driving, the CPU 302A performs processing for updating the exposure time information of the image capturing device 4A with the exposure time information of the image capturing device 4B (S8004). In other words, when driving forward, the exposure time of the image capturing device 4A that captures images in the front area of the vehicle is used, and when driving backward, the exposure time of the image capturing device 4B that captures images in the rear area of the vehicle is preferentially used. By doing such processing, it is possible to display an image in which an area which the driver wants to see is captured with an appropriate exposure, so that it is possible to display a seamless image in which the brightness of an area which the driver wants to see is optimized.

Further, when the drive shift position is P or N which indicates that the vehicle 100 is stopped in S8001, the CPU 302 calculates an average value of the values of the exposure time information of the image capturing devices 4A and 4B stored in the RAM 305, and updates the exposure time information of the image capturing devices 4A and 4B with the average value (S8003).

When the vehicle is stopped, there is no information whether the driver wants to drive the vehicle in the forward direction or the backward direction. Therefore, by controlling the exposure time so that the averaged brightness is realized and the entire image can be seen, it is possible to provide an easy-to-see image to the driver.

It is possible to control so that the brightness of each image is optimized when the vehicle is stopped without performing the processing of S8003. In this case, the driver can determine on the basis of images captured in all the directions with an optimal brightness.

[About frame controller 406A] In the second embodiment, it is described that the frame controller 406A controls the image capturing timing of the camera 401A on the basis of the count value of the cycle time register 405A and the number of frames per second of the camera controller 402A.

The frame controller 406A can also be configured as hardware.

Hereinafter, an example of the controller 406A configured as hardware will be described.

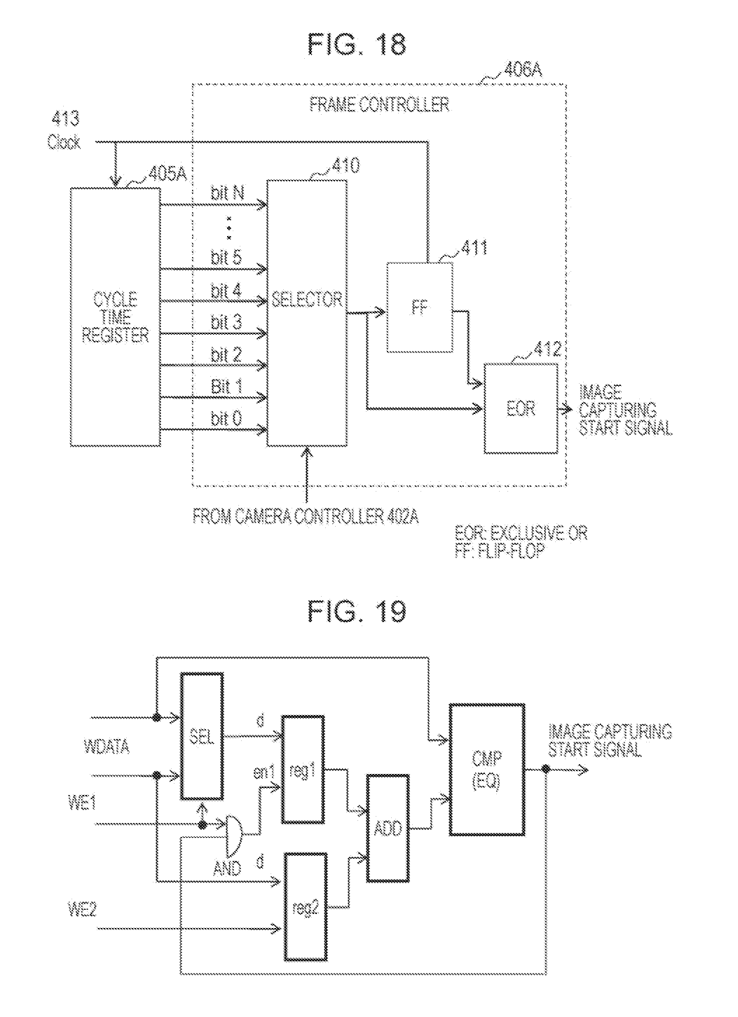

FIG. 18 is a configuration diagram of a first example of the frame controller 406 A. In FIG. 18, reference numeral 410 denotes a selector for performing an output when the value of the cycle time register 405A corresponds to the value transmitted from the camera controller 402A in S5002.

In S5002 described above, for ease of description, it is assumed that the camera controller 402A transmits the number of frames per second to the frame controller 406A. However, actually, the camera controller 402A converts the number of frames per second into the count number of clocks corresponding to the number of frames per second and inputs the count number of clocks into the selector.

For example, when the number of frames per second is 32 and a clock 413 is a signal of 32768 Hz, a binary number=“10000000000” corresponding to 1024 which is the count number of clocks is transmitted to the selector 410. Then, the selector 410 masks the value of the cycle time register 405A except for the 11th digit from the left. As a result, only the value of the 11th digit form the left of the cycle time register 405A is outputted from the selector 410. When the value outputted from the selector 410 changes, an FF 411 and an EOR 412 output an image capturing start signal to the camera 401A. In this way, an image capturing synchronized with the value of the cycle time register 405A can be performed. This processing is performed also in the image capturing device 402B, and when the cycle time registers 405A and 405B become the same specified value, the cameras 401A and 401B start image capturing at the same time. As described above, the values of the cycle time registers mounted on each image capturing device are synchronized so that the values are the same at the same time, so that staring image capturing with the same specified value means starting image capturing at the same image capturing timing. Therefore, by using the frame controller 406A, frame image capturing can be performed at the same timing by a plurality of image capturing devices.

Another example will be described. FIG. 19 is a configuration diagram of a second example of the frame controller 406A.

In the second example, data from the cycle time register 405A and information converted into the count number of clocks corresponding to the number of frames per second from the camera controller 402A can be inputted as WDATA. The cycle time register 405A performs output to a WE1 line in accordance with count-up. When the camera controller 402A outputs period information converted into the count value, the camera controller 402A also outputs an enable signal to a WE2 line. In other words, when the enable signal is present on the WE1 line, it is indicated that count-up is performed in the cycle time register 405A, and when the enable signal is present on the WE2 line, it is indicated that there is an output from the camera controller 402A.

In the second example, an SEL 20001 is a selector for performing output to a register reg1-20002 described below when there is an output on the WE1 line. The Reg1-20002 is a register for holding an output that is outputted from the cycle time register 405A when the previous frame synchronization is performed, and the reg1-20002 holds data d from the SEL 20001 when an enable signal en1 is inputted. A reg2-20003 is a register for holding the period information from the camera controller 402A, and the reg2-20003 holds data of WDATA when there is an enable signal from the WE2 line, that is, an enable signal from the camera controller 402A. An ADD 20004 is an adder for adding together an output from the register reg1-20002 and an output from the register reg2-20003, and a CMP 20005 is a comparator for outputting an image capturing start signal when the next frame synchronization timing corresponds to the value of the cycle time register.

An AND is a logical AND circuit whose input terminals are connected to an output of the comparator 20005 and the WE1 line. The logical AND circuit AND writes a value outputted from the cycle time register 405A to the register reg1-20002 in accordance with the image capturing start signal.

Hereinafter, an operation of the second example of the frame controller 406A will be described on the basis of the above configuration.

First, when the camera controller 402A outputs an enable signal on the WE2 line and outputs a count value corresponding to a camera period to the WDATA, the register reg2-20003 holds the value.

When the cycle time register 405A counts up, the cycle time register 405A outputs an enable signal on the WE1 line. When the image capturing start signal is outputted from the comparator CMP 20005, the logical AND circuit AND outputs the enable signal to the register reg1-20002. Therefore, the register reg1-20002 stores the value of the cycle time register 405A in synchronization with the image capturing signal from the comparator CMP 20005.

The adder ADD 20004 outputs a value captured by adding together the stored value and the period information held by the register reg2-20003. This value is a count value of the timing for starting the next image capturing. The comparator CMP 20005 compares the output from the adder ADD 20004 (the count value of the timing for starting the next image capturing) and the count value from the cycle time register 405A, and outputs the image capturing start signal when the output from the adder ADD 20004 matches the count value from the cycle time register 405A.

As described above, when the image capturing signal is updated, the value of the register reg1-20002 is also updated, so that the output value from the adder ADD 20004 is updated to a count value indicating the next image capturing timing. Therefore, the output of the comparator CMP 20005 is stopped until the output from the adder ADD 20004 (the count value of the timing for starting the next image capturing) matches the count value from the cycle time register 405A.

In the first example, the value of the cycle time register 405A is selected by masking the cycle time register 405A except for specified bits, so that only a multiple of 2 level selections is possible. On the other hand, the frame control means in the second example determines the count value of the next image capturing start timing by addition, so that it is possible to set the image capturing start timing without being limited to the multiple of 2 level selections.

[About communication control by 1394 Automotive] Hereinafter, communication control of 1394 Automotive in the second embodiment will be described on the basis of the control from S5009 to S5111 in FIG. 14.

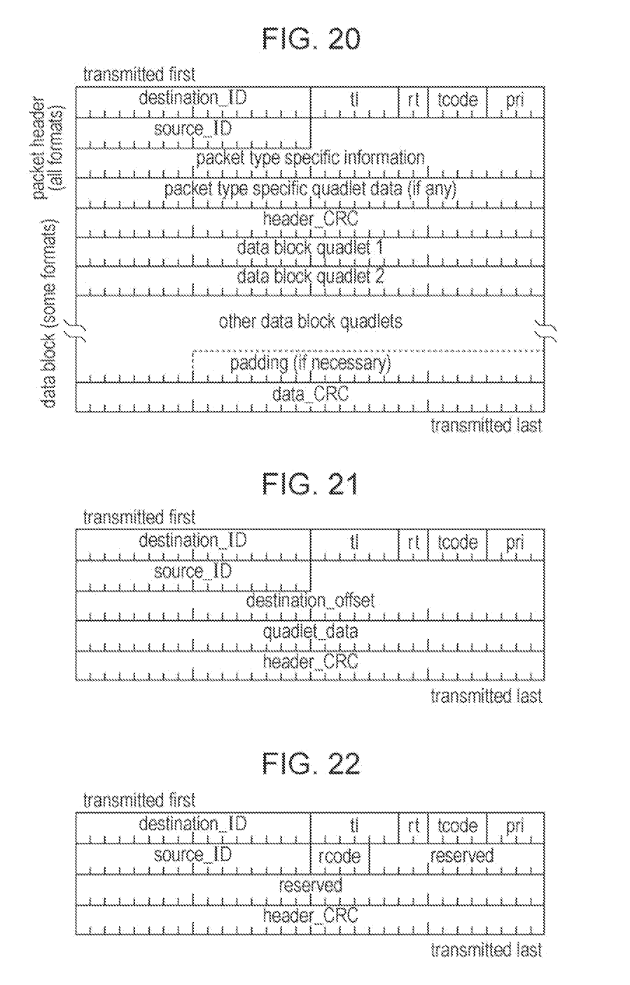

First, FIG. 20 is a basic structure 10006 of an asynchronous packet of 1394 Automotive. In the 1394 Automotive, packets of a write request 10007 and a write response shown in FIGS. 21 and 22 are specified in a specification of asynchronous packet, and this embodiment uses the specification. In the 1394 Automotive, when network connection is completed, unique IDs are provided to each image capturing device and a control device. For example, in S5009, when the control device 3A transmits information for updating data to the image capturing device 4A, such as transmitting exposure time information and the number of frames per second to an image capturing device, the communication controller 304A in the control device 3A inputs the ID of the image capturing device into the area of Destination_ID in the write request packet and inputs the ID of the control device into the area of Source_ID.

Also, the communication controller 304A inputs an address value for identifying the exposure time information and the number of frames per second in the image capturing device into the area of Destination_Offset. Further, the communication controller 304A inputs data desired to be written into the area of Quadlet_data. In this way, the write packet is generated.

When the communication controller 304A transmits the packet to the 1394 network, the communication controller 404A in the image capturing device 4A receives the packet. When the Destination_ID matches the ID of the image capturing device 4A, the communication controller 404A sends the information to the camera controller 402A. The camera controller 402A updates data in the RAM 403 corresponding to data type in the Destination_Offset with data in the area of Quadlet_data.

When the Destination_ID does not match the ID of the image capturing device 4A, the communication controller 404A transfers the write request packet to the image capturing device 4B.

When the Destination_ID matches the ID of the image capturing device 4A, the image capturing device 4A exchanges the Destination_ID and the Source_ID to generate a write response packet 10008 shown in FIG. 22, and transmits the write response packet to the control device 3A. When the control device 3A receives the response packet, the control device 3A recognizes that the write request packet is successfully written.

Three examples for controlling the frame period and the frame synchronization timing by using the above command will be described below.

Although the control described above performs synchronization, instructions to the image capturing devices 4A and 4B that are written from the control device 3A are performed individually. Therefore, for example, it is possible to have four image capturing devices and synchronize only some of the image capturing devices, such as not synchronizing one of the image capturing devices.

In this case, the image capturing devices to be synchronized are controlled on the basis of the processing described in the second embodiment, and the image capturing device not to be synchronized is controlled on the basis of the processing described in the first embodiment.

Similarly, for example, it is possible to have four image capturing devices and individually synchronize two image capturing devices and the other two image capturing devices. Although, the embodiments are described using a vehicle as an example, a device to which cameras are attached is not limited to a vehicle but may be any movable body.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A camera control apparatus which controls an exposure time upon capturing a moving image by a camera mounted on a movable body, comprising:
a memory for storing frame information of the moving image captured by the camera;
an image capturing unit for capturing the frame information from the camera and storing the frame information into the memory;
a first candidate generator for generating the first candidate of the exposure time on the basis of a speed of the movable body;
a second candidate generator for generating a second candidate of the exposure time on the basis of the frame information stored in the memory; and
a updating unit for selecting a shorter time between the first candidate and the second candidate, and for updating the exposure time to the selected candidate.

2. The camera control apparatus according to claim 1,
wherein the first candidate generator generates the first candidate becoming a shorter time by quickening of the speed of the movable body.

3. The camera control apparatus according to claim 1,
wherein
the movable body is a vehicle, and
the first candidate generator generates the first exposure candidate on the basis of a vehicle speed pulse information and drive shift information, the vehicle speed pulse information being captured from the vehicle.

4. The camera control apparatus according to claim 1,
wherein the second candidate generator generates the second candidate on the basis of a shading of each of pixels of the frame information stored in the memory.

5. The camera control apparatus according to claim 1,
wherein
the movable body has a plurality of the cameras,
the image capturing unit captures frame information of the moving images taken by each of the cameras and stores the frame information of each of the captured moving image into the memory,
the second candidate generator generates a plurality of the second candidates on the basis of the frame information of each of the moving image stored in the memory, and
the updating unit updates a plurality of the exposure times of each of the cameras to each of selected times of the camera, each selected time being selected respectively shorter time between the first candidate and each second candidates of each of the cameras

6. The camera control apparatus according to claim 1,
wherein
the movable body has a plurality of the cameras,
the image capturing unit captures frame information of the moving image taken by each of the cameras and stores each of the captured the frame information of the moving image into the memory,
the second candidate generator generates a plurality of the second candidates on the basis of each of the moving image stored in the memory, and
the updating unit selects a plurality of shorter time between the first candidate and each of the second candidates, and updates the exposure time of each of the cameras to one of the selected candidate.

7. The camera control apparatus according to claim 1,
wherein
the movable body is a vehicle,
the movable body has a plurality of the cameras,
the updating unit selects a shorter time between the first candidate and the second candidates of one of the cameras when a drive shift of the vehicle is at a position corresponding to propulsion of the vehicle, the one of the cameras being mounted at position taking moving image at a forward of the vehicle, and
the updating unit updates the exposure time of each of the cameras to the selected time.

8. A camera control method for controlling a camera mounted on a movable body, comprising:
storing frame information of the moving image captured by the camera;
capturing the frame information from the camera and storing the frame information into the memory;
generating the first candidate of the exposure time on the basis of a speed of the movable body;
generating a second candidate of the exposure time on the basis of the frame information stored in the memory;
selecting a shorter time between the first candidate; and
updating the exposure time to the selected candidate.

9. A camera control apparatus including a counter and a communicator, the counter counting clock signals, the communicator setting the count value of the counter to the same value as the count value of other devices and communicating on the basis of count value of the counter, the camera control apparatus comprising:
a first register for holding a count value upon being outputted a moving image beginning signal;
a second register for holding a count value corresponds to taking moving image intervals;
an accumulator for adding the count value in the first register and the count value in the second register; and
an output unit for outputting the moving image beginning signal to the camera when the added value at accumulator is same as the count value of the counter.
